(19) United States
(12) Patent Application Publication
(10) Pub. No.: US 2018/0086190 A1
(43) Pub. Date: Mar. 29, 2018

(54) WATERPROOF TONNEAU COVER

(71) Applicants: SHENZHEN BOYANG AUTO ACCESSORY CO., LTD, SHENZHEN (CN); CYC ENGINEERING, INC., HAYWARD, CA (US)

(72) Inventor: Shiawdar Shaun YUE, Cupertino, CA (US)

(21) Appl. No.: 15/660,995

(22) Filed: Jul. 27, 2017

(30) Foreign Application Priority Data
Sep. 26, 2016 (CN) 201610853245.8

(51) Int. Cl. B60J 10/90; B60J 10/30

(52) U.S. Cl. CPC B60J 10/90; B60J 7/1607; B60J 10/30

(57) ABSTRACT

A waterproof tonneau cover includes a cover body, at least one waterproof bar and at least one waterproof shielding piece. The waterproof bar is mounted on a bottom of a side portion of the cover body. The waterproof shielding piece is attached to the side portion of the cover body and positioned on a top of the waterproof bar to cover a gap between the cover body and the waterproof bar, thereby preventing raindrops from entering a cargo bed through the gap.

### BACKGROUND OF THE INVENTION

### Field of the Invention

The present invention relates to vehicle accessories, and more particularly to a waterproof tonneau cover that is used for a truck having an open bed, such as a pick-up truck.

### Description of the Related Art

A pick-up truck is a truck that has a cargo bed connected to a rear end of a cab. In order to prevent sunlight, raindrops or unwanted objects from entering the open cargo bed, a pick-up truck is usually equipped with a tonneau cover so as to cover the top of the truck bed.

With reference to FIG. 1, for waterproof, a conventional tonneau cover 90 is provided with waterproof bars 91 on its edges, especially on a bottom of its front edge which is close to a cab of a truck, so as to provide a better effect of blocking splashing raindrops. However, in FIG. 1, there is still a gap existing between the waterproof bar 91 and a cushion pad 92 mounted on a corner of the tonneau cover, therefore it is still possible that raindrops may enter the truck bed when driving in the rain.

Therefore, it is necessary to provide a waterproof truck-bed cover to overcome the problems existing in the conventional technology.

### SUMMARY OF THE INVENTION

In view of the shortcomings of the conventional technology, an object of the present invention is to provide a waterproof tonneau cover, which structure is able to effectively prevent entrance of raindrops.

In order to achieve the foregoing object, the present invention provides a waterproof tonneau cover including: a cover body; at least one waterproof bar mounted on a bottom of a side portion of the cover body; and at least one waterproof shielding piece attached to the side portion of the cover body and positioned on a top of the waterproof bar to cover a gap between the cover body and the waterproof bar.

In one embodiment of the present invention, the waterproof shielding piece has an elongated rectangular sheet shape; a length of the waterproof shielding piece is greater than that of the waterproof bar and is less than that of the side portion of the cover body; a direction along the length of the waterproof shielding piece is parallel to a direction of the length of the waterproof bar.

In one embodiment of the present invention, the waterproof shielding piece has a first attachment portion; the the first attachment portion is detachably mounted on the side portion of the cover body.

In one embodiment of the present invention, the first attachment is fixed to the side portion of the cover body by using a plurality of buttons, a loop and hook strip, magnetic attraction or screw fastening.

In one embodiment of the present invention, the first attachment portion and the side portion of the cover body have a slot and a protrusion corresponding to the slot, respectively; the first attachment portion is attached to the side portion of the cover body by a way of engaging the slot with the protrusion.

In one embodiment of the present invention, the waterproof shielding piece has a first attachment portion; the first attachment portion is permanently fixed to the side portion of the cover body.

In one embodiment of the present invention, the first attachment portion is permanently fixed to the side portion of the cover body by sewing or adhesion.

In one embodiment of the present invention, the first attachment portion of the waterproof shielding piece is positioned on an upper elongated side portion of the waterproof shielding piece; a lower elongated side portion of the waterproof shielding piece extends obliquely in a downward direction away from an outer side of the cover body.

In one embodiment of the present invention, the first attachment portion of the waterproof shielding piece is positioned between an upper elongated side portion and a lower elongated side portion of the waterproof shielding piece; wherein the upper elongated side portion of the waterproof shielding piece extends obliquely in a upward direction towards the cover body; and the lower elongated side portion of the waterproof shielding piece extends obliquely in a downward direction away from the cover body.

In one embodiment of the present invention, the waterproof shielding piece further has a second attachment portion; the second attachment portion is positioned on a lower elongated side portion of the waterproof shielding piece; the lower elongated side portion of the waterproof shielding piece is detachably fixed to the cargo bed with the second attachment portion.

In one embodiment of the present invention, the waterproof shielding piece includes at least two waterproof shielding units; the waterproof shielding units are connected to one another with a longer side portion thereof.

In one embodiment of the present invention, the waterproof tonneau cover comprises at least three of the waterproof shielding pieces, wherein the waterproof shielding pieces are mounted on a front side, a left side and a right side of the cover body, respectively.

The present invention mainly uses a waterproof shielding piece attached to a side portion of a tonneau cover where a waterproof bar is mounted to cover a top of the waterproof bar, so that a gap existing between the waterproof bar and a cover body of the tonneau cover is blocked, thereby effectively preventing raindrops from entering the gap.

### BRIEF DESCRIPTION OF THE DRAWINGS

FIG. 1 is a partial perspective view of a conventional tonneau cover structure used in a pickup truck;

FIG. 2 is a side view showing a waterproof tonneau cover mounted on a cargo bed of a truck according to a preferred embodiment of the present invention;

FIG. 3 is a partial perspective view of a waterproof tonneau cover from a bottom view angle according to a preferred embodiment of the present invention;

FIG. 3a is a structural view of a cover material of the waterproof tonneau cover according to a preferred embodiment of the present invention;

FIG. 4 is a partial side view of the waterproof tonneau cover according to a preferred embodiment of the present invention;

FIGS. 5a to 5d are structures view showing a waterproof shielding piece of the waterproof tonneau cover is attached to a cover body through different attaching methods;

FIG. 6 is a partial side view of the waterproof tonneau cover according to another preferred embodiment of the present invention;

FIG. 7 is a partial side view of the waterproof tonneau cover according to still another preferred embodiment of the present invention; and

FIG. 8 is a partial side view of the waterproof tonneau cover according to yet another preferred embodiment of the present invention.

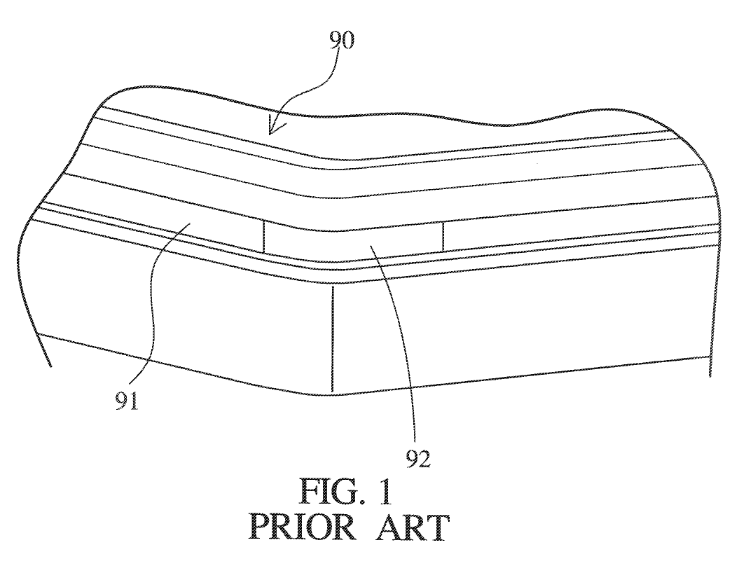

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

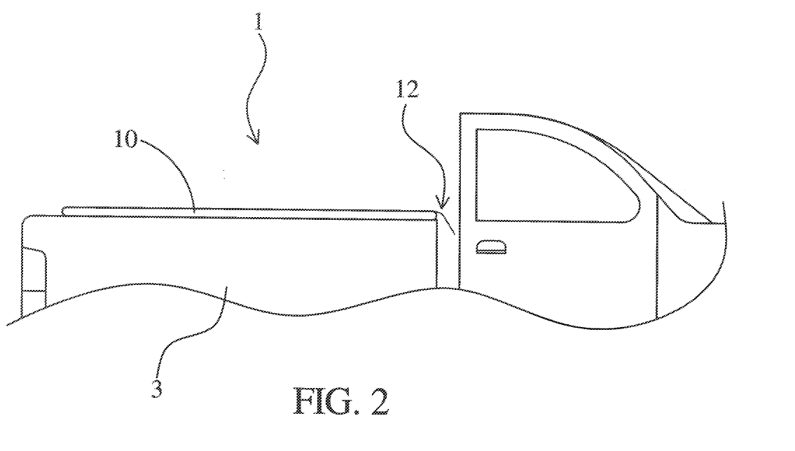

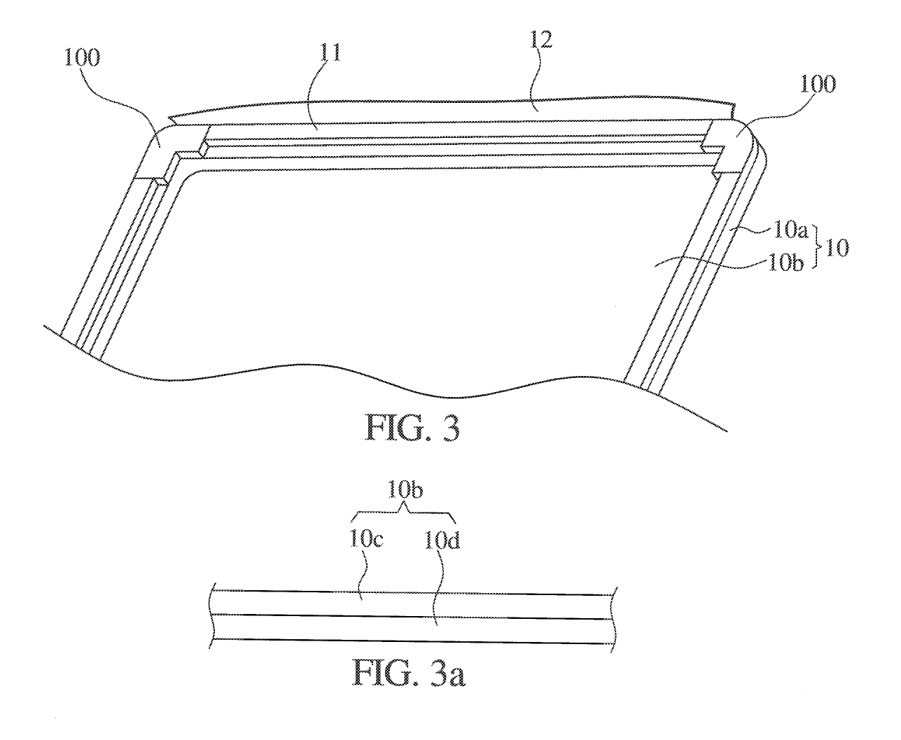

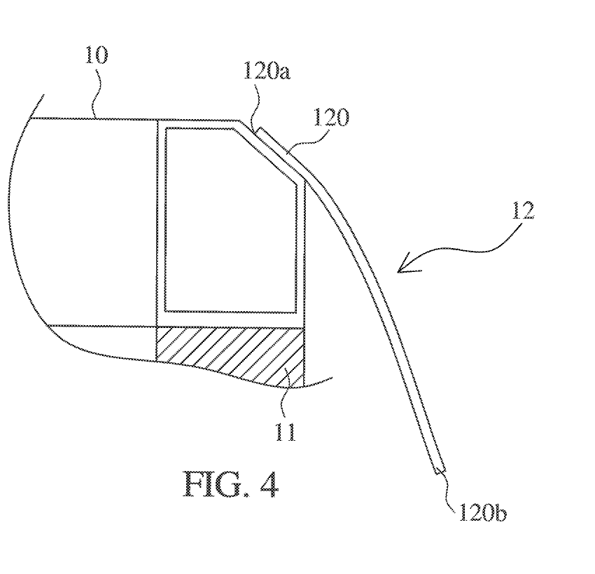

With reference to FIG. 2, a waterproof tonneau cover 1 of the present invention is mainly applied in a vehicle with a cargo bed 3, such as a common pickup truck, and is configured to cover a top of the cargo bed 3 so as to further provide an effect of shielding and waterproofing. With further reference to FIGS. 3 and 4, the waterproof tonneau cover 1 provided by the present invention mainly includes a cover body 10, at least one waterproof bar 11 and at least one waterproof shielding piece 12.

As shown in FIG. 3, the cover body 10 has a rectangular shape and is mainly constructed by a rectangular frame 10a and a cover material 10b covering the frame 10a. The frame 10a may be a foldable frame which is assembled by connecting multiple minor frames. A user may store the waterproof tonneau cover 1 by folding it. The cover material 10b may be soft or hard material, such as canvas, artificial leather, plastic plate or aluminum plate. The cover body 10 has four corners, each of which is provided with a cushion pad 100.

In one embodiment, as shown in FIG. 3a, the cover material 10b may be formed by at least two different materials. For example, the cover material 10b may be constructed by a soft material 10c and a hard material 10d, wherein the soft material 10c may be covering the hard material 10d. Specifically, soft material, such as canvas or artificial leather, may be adhered on hard material, such as plastic plate or aluminum plat. Thus, the appearance of the cover can be improved by using such composite materials. Furthermore, the soft material 10c (canvas or artificial leather) on the hard material 10d can be replaced for changing different outer appearances.

As shown in FIG. 3 and FIG. 4, the waterproof bar 11 is mounted on a bottom of a side portion of the cover body 10, and is preferably positioned between two of the cushion pads 100. The waterproof bar 11 may be made of waterproof materials, such as foam rubber, rubber or the like.

As shown in FIG. 3 and FIG. 4, the waterproof shielding piece 12 is attached to the side portion of the cover body 10 and is positioned on a top of the waterproof bar 11 so as to cover a gap between the cover body 10 and the waterproof bar 11. Specifically, the waterproof shielding piece 12 may have an elongated rectangular sheet shape and may be a flexible piece made by elastic waterproof material, such as rubber. A direction along the length of the waterproof shielding piece 12 is parallel to a direction of the length of the waterproof bar 11; and a length of the waterproof shielding piece 12 is greater than that of the waterproof bar 11 and is less than that of the side portion of the cover body 10 so that the gap between the cover body 10 and the waterproof bar 11 can be fully covered. A width of the waterproof shielding piece 12 may be 25 cm to 30 cm to cover the gap between the cover body 10 and the waterproof bar 11.

Therefore, even if there are any gaps existing between the waterproof bar 11 and the cover body 10, the waterproof shielding piece 12 having a length greater than the waterproof bar 11 can fully shield those gaps to provide further protection and shielding effect, thereby greatly lowering the possibility of having raindrops entering the cargo bed on rainy days.

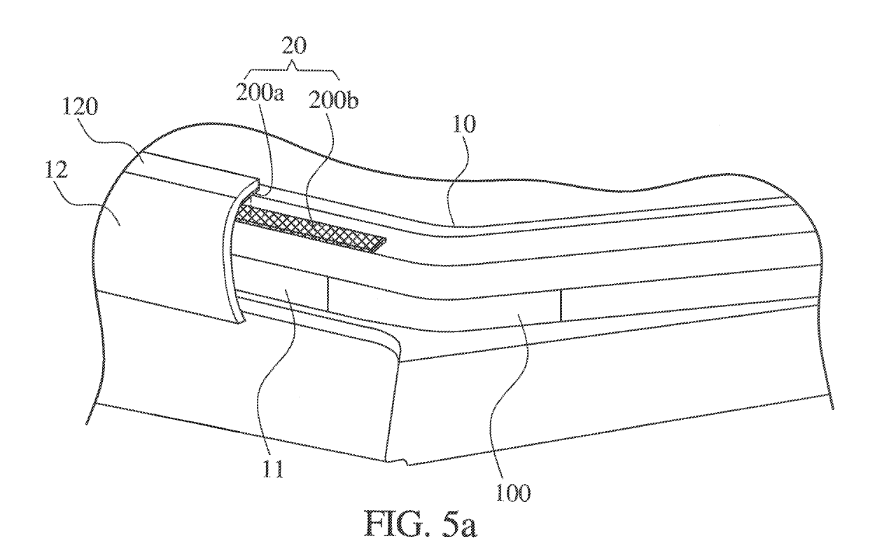

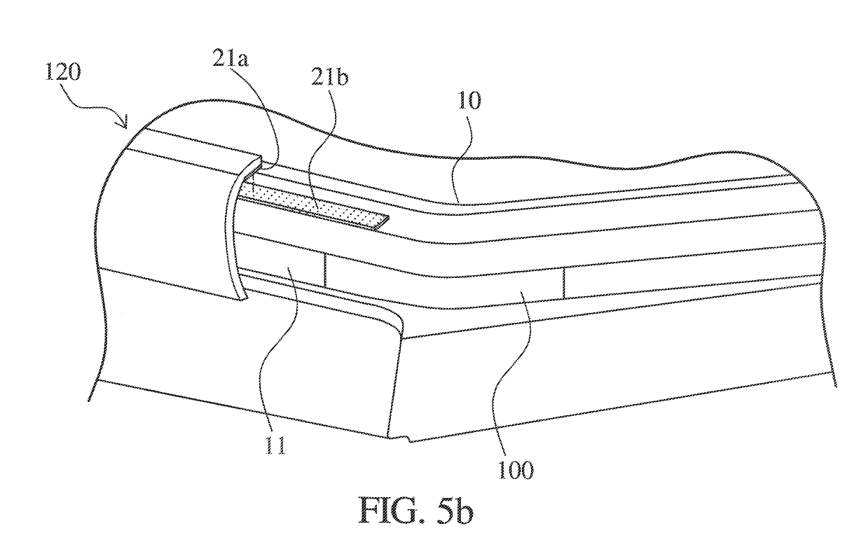

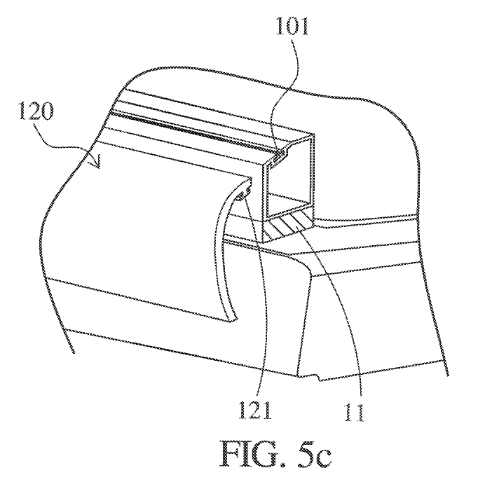

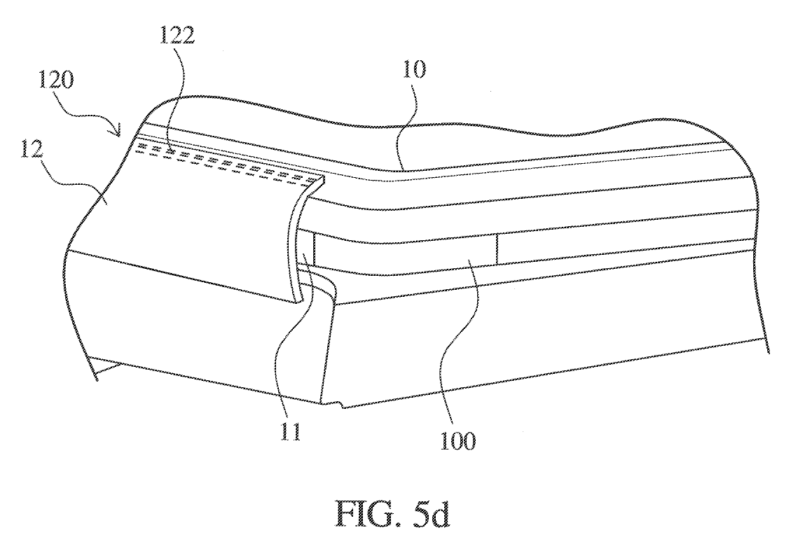

In one embodiment, the waterproof shielding piece 12 may have a first attachment portion 120 so as to be detachably mounted on the side portion of the cover body 10 through with first attachment portion 120. As shown in FIG. 5a, the first attachment portion 120 may be fixed to the side portion of the cover body 10 by using a loop and hook strip, wherein a hook surface 200a (or loop surface) of a loop and hook strip 20 may be mounted on the first attachment portion 120; a loop surface 200b (or hook surface) of the loop and hook strip 20 may be mounted on the side portion of the cover body 10. In another embodiment, as shown in FIG. 5b, the first attachment portion 120 may be fixed to the side portion of the cover body 10 by magnetic attraction; wherein a magnetic bar 21a may be mounted on the first attachment portion 120; another magnetic bar 21b providing an opposite polarity surface may be correspondingly mounted on the side portion of the cover body 10; or a front frame portion of the cover body 10 may be formed by a metal which can be attracted by magnet (such as iron or alloy thereof). In another embodiment, as shown in FIG. 5c, the first attachment portion 120 and the side portion of the cover body 10 may have a slot 101 and a protrusion 121 corresponding to the slot 101, respectively, such that the first attachment portion 120 can be detachably fixed to the side portion of the cover body 10 by a way of engaging the slot 101 with the protrusion 121. Besides, the first attachment portion 120 may be detachably fixed to the side portion of the cover body 10 by using a plurality of buttons or screw fastening.

Since the waterproof shielding piece 12 is detachably fixed to the side portion of the cover body 10, it is convenient for the user to replace the waterproof shielding piece 12 when it is broken.

In other embodiments, the waterproof shielding piece 12 may be permanently fixed to the side portion of the cover body 10 with the first attachment portion 120. For example, as shown in FIG. 5d, the first attachment portion 120 may be permanently fixed to the side portion of the cover body 10 by sewing, wherein the first attachment portion 120 is fixed to the cover material of the cover body by sewing threads 122. Or the first attachment portion 120 may be permanently fixed to the side portion of the cover body 10 by adhesion.

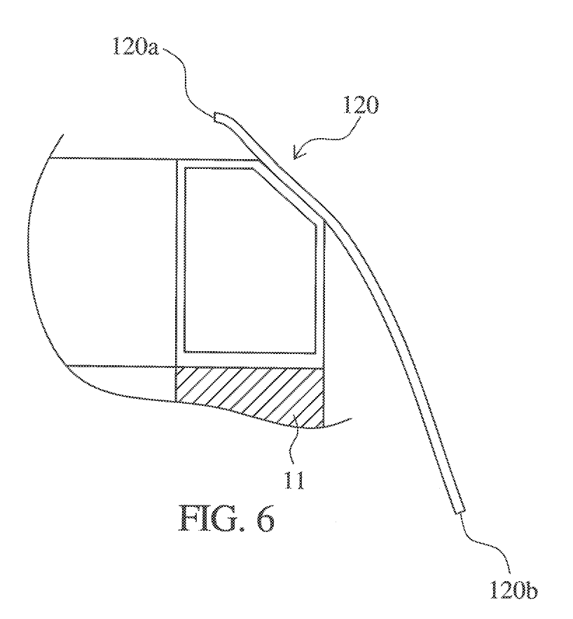

Besides, the position of the first attachment portion 120 of the waterproof shielding piece 12 may differ based on different requirements. For example, as shown in FIG. 4, the first attachment portion 120 of the waterproof shielding piece 12 may be positioned on an upper elongated side portion 120a of the waterproof shielding piece 12, and a lower elongated side portion 120b (opposite the upper elongated side portion 120a) of the waterproof shielding piece 12 may extend obliquely in a downward direction away from an outer side of the cover body 10. Or in anther embodiment, as shown in FIG. 6, the first attachment portion 120 of the waterproof shielding piece 12 may be positioned between an upper elongated side portion 120a and a lower elongated side portion 120b of the waterproof shielding piece 12; wherein the upper elongated side portion 120a extends obliquely in a upward direction towards the cover body 10; and the lower elongated side portion 120b extends obliquely in a downward direction away from the cover body 10.

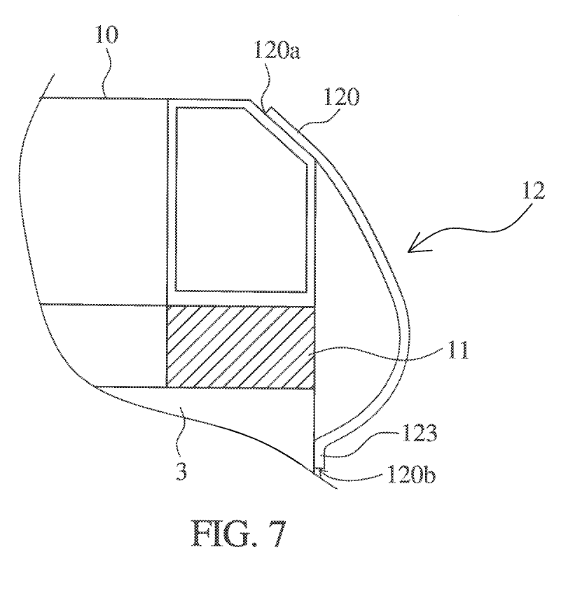

In one embodiment, as shown in FIG. 7, the waterproof shielding piece 12 may further have a second attachment portion 123. The second attachment portion 123 is positioned on a lower elongated side portion 120b of the waterproof shielding piece 12. When the waterproof tonneau cover 1 is installed on the cargo bed 3 as shown in FIG. 2, the lower elongated side portion 120b of the waterproof shielding piece 12 can be detachably fixed to the cargo bed 3 with the second attachment portion 123 so as to prevent the lower elongated side portion of the waterproof shielding piece 12 from flapping the cargo bed 3 and making noises under strong winds during truck driving.

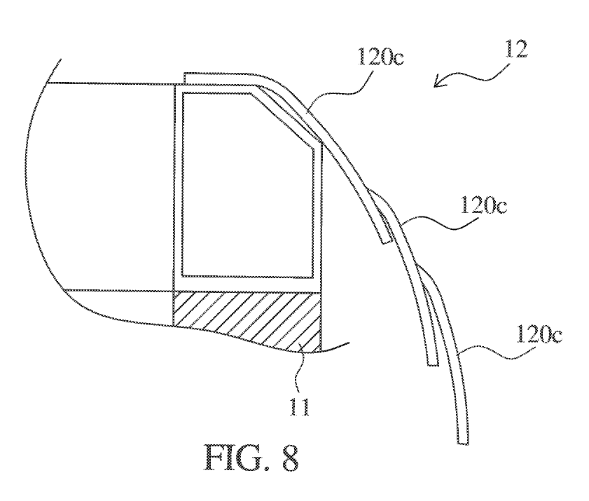

In one embodiment, as shown in FIG. 8, the waterproof shielding piece 12 may include at least two waterproof shielding units 120c; the waterproof shielding units 120c are connected to one another with a longer side portion thereof and are partially overlapped with each other. With such a structure, the effect of blocking the entrance of raindrops from gaps can be more enhanced.

In one embodiment, the waterproof tonneau cover of the present invention may include at least three of the waterproof shielding pieces 12. The waterproof shielding pieces 12 are mounted on a front side, a left side and a right side of the cover body 10, respectively, so as to effectively prevent raindrops from entering the cargo bed through gaps at the front side, the left and the right sides.

In conclusion, the waterproof tonneau cover of the present invention mainly has a waterproof shielding piece attached to a side portion of a cover body on which a waterproof bar is mounted so that the waterproof shielding piece with a longer length can cover a top of the waterproof bar and further block a gap existing between the waterproof bar and the cover body, thereby effectively preventing raindrops from entering from the gap. Thus, the waterproof tonneau cover of the present invention can provide further protection and shielding effect for a cargo bed.

The present invention has been described with preferred embodiments thereof, and it is understood that many changes and modifications to the described embodiment can be carried out without departing from the scope and the spirit of the invention that is intended to be limited only by the appended claims.

What is claimed is:

1. A waterproof tonneau cover configured to cover a cargo bed of a truck, comprising:
a cover body,
at least one waterproof bar mounted on a bottom of a side portion of the cover body; and
at least one waterproof shielding piece being attached to the side portion of the cover body and being positioned on a top of the waterproof bar to cover a gap between the cover body and the waterproof bar, the waterproof shielding piece has an elongated rectangular sheet shape; wherein a length of the waterproof shielding piece is greater than that of the waterproof bar and is less than that of the side portion of the cover body; a direction along the length of the waterproof shielding piece is parallel to a direction of the length of the waterproof bar; the waterproof shielding piece has a first attachment portion; the first attachment portion is permanently fixed to the side portion of the cover body by sewing; the first attachment portion of the waterproof shielding piece is positioned on an upper elongated side portion of the waterproof shielding piece; a lower elongated side portion of the waterproof shielding piece extends obliquely in a downward direction away from an outer side of the cover body.

2. A waterproof tonneau cover configured to cover a cargo bed of a truck, comprising:
a cover body;
at least one waterproof bar mounted on a bottom of a side portion of the cover body; and
at least one waterproof shielding piece attached to the side portion of the cover body and positioned on a top of the waterproof bar to cover a gap between the cover body and the waterproof bar.

3. The waterproof tonneau cover as claimed in claim 2, wherein the waterproof shielding piece has an elongated rectangular sheet shape; a length of the waterproof shielding piece is greater than that of the waterproof bar and is less than that of the side portion of the cover body; a direction along the length of the waterproof shielding piece is parallel to a direction of the length of the waterproof bar.

4. The waterproof tonneau cover as claimed in claim 3, wherein the waterproof shielding piece has a first attachment portion; the waterproof shielding piece is detachably mounted on the side portion of the cover body with the first attachment portion.

5. The waterproof tonneau cover as claimed in claim 4, wherein the first attachment is fixed to the side portion of the cover body by using a plurality of buttons, a loop and hook strip, magnetic attraction or screw fastening.

6. The waterproof tonneau cover as claimed in claim 4, wherein the first attachment portion and the side portion of the cover body have a slot and a protrusion corresponding to the slot, respectively; the first attachment portion is attached to the side portion of the cover body by a way of engaging the slot with the protrusion.

7. The waterproof tonneau cover as claimed in claim 3, wherein the waterproof shielding piece has a first attachment portion; the waterproof shielding piece is permanently fixed to the side portion of the cover body with the first attachment portion.

8. The waterproof tonneau cover as claimed in claim 7, wherein the first attachment portion is permanently fixed to the side portion of the cover body by sewing or adhesion.

9. The waterproof tonneau cover as claimed in claim 4, wherein the first attachment portion of the waterproof shielding piece is positioned on an upper elongated side portion of the waterproof shielding piece; a lower elongated side portion of the waterproof shielding piece extends obliquely in a downward direction away from an outer side of the cover body.

10. The waterproof tonneau cover as claimed in claim 4, wherein the first attachment portion of the waterproof shielding piece is positioned between an upper elongated side portion and a lower elongated side portion of the waterproof shielding piece; wherein the upper elongated side portion of the waterproof shielding piece extends obliquely in a upward direction towards the cover body; and the lower elongated side portion of the waterproof shielding piece extends obliquely in a downward direction away from the cover body.

11. The waterproof tonneau cover as claimed in claim 9, wherein the waterproof shielding piece further has a second attachment portion; the second attachment portion is positioned on a lower elongated side portion of the waterproof shielding piece; the lower elongated side portion of the waterproof shielding piece is detachably fixed to the cargo bed with the second attachment portion.

12. The waterproof tonneau cover as claimed in claim 2, wherein the waterproof shielding piece includes at least two waterproof shielding units; the waterproof shielding units are connected to one another with a longer side portion thereof.

13. The waterproof tonneau cover as claimed in claim 2, wherein the waterproof tonneau cover comprises at least three of the waterproof shielding pieces, wherein the waterproof shielding pieces are mounted on a front side, a left side and a right side of the cover body, respectively.
